(19) United States
(12) Patent Application Publication
(10) Pub. No.: US 2020/0033875 A1
(43) Pub. Date: Jan. 30, 2020

(54) IMAGE SENSOR SYSTEM AND AUTONOMOUS DRIVING SYSTEM USING THE SAME

(71) Applicant: LG Electronics Inc., Seoul (KR)

(72) Inventor: Daehyun AN, Seoul (KR)

(21) Appl. No.: 16/590,956

(22) Filed: Oct. 2, 2019

(30) Foreign Application Priority Data
Aug. 30, 2019 (KR) 10-2019-0107764

(51) Int. Cl. G05D 1/02; G05D 1/00; G06K 9/62; G06K 9/00; H04W 4/40

(52) U.S. Cl. CPC G05D 1/0242; G05D 1/0246; H04W 4/40; G06K 9/6212; G06K 9/00791; G05D 1/0094

(57) ABSTRACT

Provided are a camera, a control method thereof, and an autonomous driving system including the camera. The camera includes an active filter electrically controlled to allow light having an infrared wavelength to pass therethrough and block the light having the infrared wavelength, an image sensor converting light passing through the active filter into an electrical signal and outputting an image signal, an image analyzer analyzing the image signal obtained from the image sensor, and a filter controller selecting a wavelength of light passing through the active filter by electrically controlling an operation mode of the active filter on the basis of a result of analyzing the image signal. According to the lidar system, an autonomous vehicle, an Al device, and an external device may be linked with an artificial intelligence module, a drone, a robot, an Augmented Reality device, a Virtual Reality device, a device associated with 5G services, etc.

### CROSS-REFERENCE TO RELATED APPLICATION

This application claims the benefit of Korean Patent Application No. 10-2019-0107764 filed on Aug. 30, 2019, the entire contents of which is incorporated herein by reference for all purposes as if fully set forth herein.

### BACKGROUND OF THE DISCLOSURE

### Field of the Disclosure

The present disclosure relates to an image sensor system and more particularly, to an image sensor system for selecting a wavelength of light received by an image sensor on the basis of an analysis result of an image obtained by the image sensor, and an autonomous driving system using the same.

### Related Art

Vehicles, in accordance with the prime mover that is used, may be classified into an internal combustion engine vehicle, an external combustion engine vehicle, a gas turbine vehicle, an electric vehicle or the like.

An autonomous vehicle refers to a vehicle that may be driven by itself without operation by a driver or a passenger and an autonomous driving system refers to a system that monitors and controls such an autonomous vehicle so that the autonomous vehicle may be driven by itself.

In the autonomous driving system, demand for a technology that provides a safer driving environment for passengers or pedestrians, as well as a technology for controlling a vehicle to quickly travel to a destination has increased. To this end, autonomous vehicles require various sensors to quickly and accurately sense a surrounding terrain and objects in real time.

A plurality of cameras may be installed in an autonomous vehicle. About 7 to 10 cameras may be arranged indoors, front, side, and rear in one autonomous vehicle. Each camera may include a digital signal processor (DSP) chip including an image sensor that converts optical information into an image signal of a digital signal and an image signal processor (ISP) core that reproduces the image signal obtained by the image sensor. The DSP may reproduce the image signal obtained by the image sensor and analyze surrounding vehicles, people, objects, roads, signs and buildings in real time.

### SUMMARY

A camera may include an infrared filter. Research into an electrically controllable active infrared filter has been conducted but an active infrared filter suitable for mass-production is yet to be developed.

For example, an active infrared filter may be implemented by using a liquid crystal panel that allows infrared rays (IR) to be transmitted therethrough or block infrared rays (IR) by electrically controlling liquid crystal molecules. However, the liquid crystal panel has a disadvantage in that an incident angle is limited due to a polarizer and a liquid crystal layer and transmittance is lowered due to a polarizing plate. In addition, since an image sensor device analyzes external light in real time and controls the liquid crystal panel with the analysis result, a system configuration is complicated and there is a heat generation problem.

The present disclosure aims to solve the above-mentioned needs and/or problems.

The present disclosure provides a camera capable of increasing transmittance and simplifying a system configuration and an autonomous driving system using the same.

The technical subjects to be achieved by the present disclosure are not limited to the above-mentioned technical subjects and any other technical subjects that are not mentioned may be clearly understood by those skilled in the art to which the present disclosure pertains from the following descriptions.

In an aspect, a camera includes: an active filter electrically controlled to allow light having an infrared wavelength to pass therethrough and block the light having the infrared wavelength; an image sensor converting light passing through the active filter into an electrical signal and outputting an image signal; an image analyzer analyzing the image signal obtained from the image sensor; and a filter controller selecting a wavelength of light passing through the active filter by electrically controlling an operation mode of the active filter on the basis of a result of analyzing the image signal.

The active filter may allow light having an infrared wavelength band to pass through the image sensor when operating in a pass mode and block the light having the infrared wavelength band when operating in a blocking mode.

An autonomous driving system according to an embodiment of the present disclosure includes an autonomous driving apparatus that reflects object information detected by the camera in driving of a vehicle.

### BRIEF DESCRIPTION OF THE DRAWINGS

FIG. 1 is a block diagram of a wireless communication system to which methods proposed in the disclosure are applicable.

FIG. 2 is a diagram showing an example of a signal transmission/reception method in a wireless communication system.

FIG. 3 shows an example of basic operations of a user equipment and a 5G network in a 5G communication system.

FIG. 4 shows an example of a basic operation between vehicles using 5G communication.

FIG. 5 is a diagram showing a vehicle according to an embodiment of the present disclosure.

FIG. 6 is a control block diagram of the vehicle according to an embodiment of the present disclosure.

FIG. 7 is a control block diagram of an autonomous device according to an embodiment of the present disclosure.

FIG. 8 is a signal flow diagram of an autonomous device according to an embodiment of the present disclosure.

FIG. 9 is a diagram referred to for describing a usage scenario of a user according to an embodiment of the present disclosure.

FIG. 10 illustrates V2X communication to which the present disclosure may be applied.

FIG. 11 illustrates a method of allocating resource in a sidelink in which V2X is used.

FIG. 12 is a block diagram illustrating a configuration of a camera according to an embodiment of the present disclosure.

FIG. 13 is a cross-sectional view illustrating an example of an active filter according to an embodiment of the present disclosure.

FIG. 14 is a diagram illustrating a method of controlling an active filter.

FIG. 15 shows a histogram of an IR wavelength band and a visible light wavelength band.

FIG. 16A shows an example of a histogram showing a pass mode of an active filter.

FIG. 16B shows an example of a histogram showing a blocking mode of an active filter.

FIG. 17 is a flowchart illustrating a method of controlling an active filter in a time flow from starting of a vehicle to turning off a vehicle power.

FIG. 18 is a flowchart illustrating an example of a method of controlling an active filter when a pass mode and a blocking mode are repeatedly changed within a predetermined time.

FIG. 19 is a diagram illustrating an example of a process of transmitting and receiving a signal for a camera control request through V2X communication.

The accompanying drawings, which are included as part of the detailed description to help understand the present disclosure, provide an embodiment of the present disclosure and describe the technical features of the present disclosure together with the description.

### DESCRIPTION OF EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus may be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

Hereafter, a device that requires autonomous driving information and/or 5G communication (5th generation mobile communication) that an autonomous vehicle requires are described through a paragraph A to a paragraph G.

A. Example of Block Diagram of UE and 5G Network

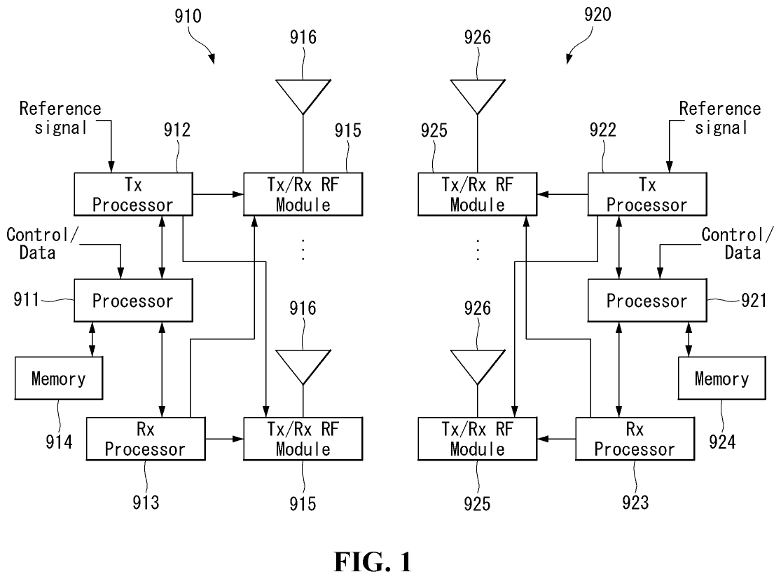

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 may perform detailed autonomous operations.

A 5G network including another vehicle communicating with the autonomous device is defined as a second communication device (920 of FIG. 1), and a processor 921 may perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

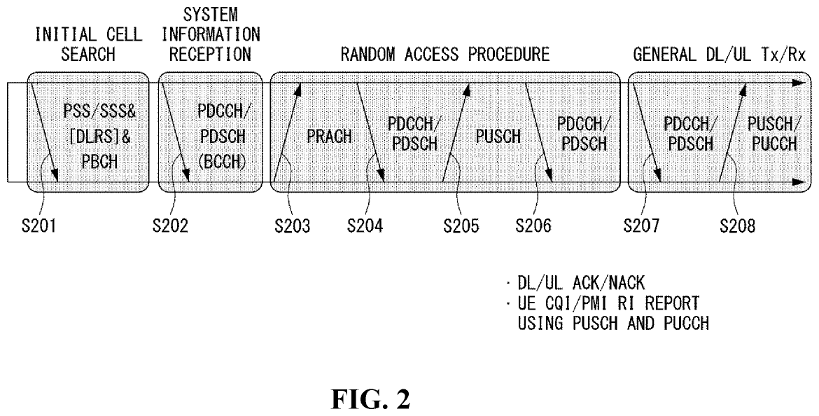

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE may receive a primary synchronization channel (P-SCH) and a secondary synchronization channel (S-SCH) from the BS to synchronize with the BS and obtain information such as a cell ID. In LTE and NR systems, the P-SCH and S-SCH are respectively called a primary synchronization signal (PSS) and a secondary synchronization signal (SSS). After initial cell search, the UE may obtain broadcast information in the cell by receiving a physical broadcast channel (PBCH) from the BS. Further, the UE may receive a downlink reference signal (DL RS) in the initial cell search step to check a downlink channel state. After initial cell search, the UE may obtain more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE may perform a random access procedure (RACH) for the BS (steps S203 to S206). To this end, the UE may transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE may perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network may configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH may be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE may perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE obtains time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/obtained through an SSS of the cell, and information on the cell ID among 336 cell ID groups is provided/obtained through a PSS.

The SSB is periodically transmitted in accordance with SSB periodicity. A default SSB periodicity assumed by a UE during initial cell search is defined as 20 ms. After cell access, the SSB periodicity may be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (System InformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure may be used for network initial access, handover, and UE-triggered UL data transmission. A UE may obtain UL synchronization and UL transmission resources through the random access procedure. The random access procedure is classified into a contention-based random access procedure and a contention-free random access procedure. A detailed procedure for the contention-based random access procedure is as follows.

A UE may transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE may receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE may be determined according to presence or absence of a random access preamble ID with respect to the preamble transmitted by the UE. If there is no response to Msg1, the UE may retransmit the RACH preamble less than a predetermined number of times while performing power ramping. The UE calculates PRACH transmission power for preamble retransmission on the basis of most recent pathloss and a power ramping counter.

The UE may perform UL transmission through Msg3 of the random access procedure over a physical uplink shared channel on the basis of the random access response information. Msg3 may include an RRC connection request and a UE ID. The network may transmit Msg4 as a response to Msg3, and Msg4 may be handled as a contention resolution message on DL. The UE may enter an RRC connected state by receiving Msg4.

C. Beam Management (BM) Procedure of 5G Communication System

A BM procedure may be divided into (1) a DL MB procedure using an SSB or a CSI-RS and (2) a UL BM procedure using a sounding reference signal (SRS). In addition, each BM procedure may include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set may be set as {SSBx1, SSBx2, SSBx3, SSBx4, . . . }. An SSB index may be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE may assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam may be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE may skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationlnfo is set for SRS resources, the same beamforming as that used for the SSB, CSI-RS or SRS is applied. However, when SRS-SpatialRelationlnfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and may be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR may refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services may be scheduled on non-overlapping time/frequency resources, and URLLC transmission may occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in

DownlinkPreemption IE for monitoring of a PDCCH that conveys DCI format 2_1. The UE is additionally configured with a corresponding set of positions for fields in DCI format 2_1 according to a set of serving cells and positionlnDCl by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE may assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. MMTC (massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information may be transmitted/received through a narrowband (e.g., 6 resource blocks (RBs) or 1 RB).

F. Basic Operation Between Autonomous Vehicles Using 5G Communication

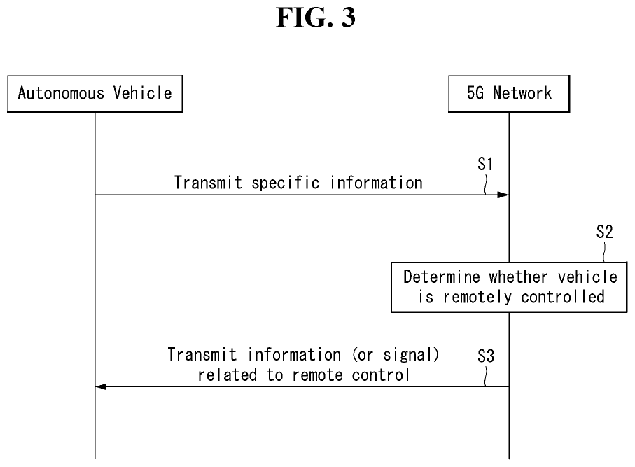

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network may determine whether to remotely control the vehicle (S2). Here, the 5G network may include a server or a module which performs remote control related to autonomous driving. In addition, the 5G network may transmit information (or signal) related to remote control to the autonomous vehicle (S3).

G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present disclosure which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to obtain DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network may transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network may transmit, to the autonomous vehicle, information (or a signal) related to remote control on the basis of the DL grant.

Next, a basic procedure of an applied operation to which a method proposed by the present disclosure which will be described later and URLLC of 5G communication are applied will be described.

As described above, an autonomous vehicle may receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle may receive a UL grant from the 5G network.

Next, a basic procedure of an applied operation to which a method proposed by the present disclosure which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information may be transmitted through a narrowband of 6 resource blocks (RBs) or 1 RB.

H. Autonomous Driving Operation Between Vehicles Using 5G Communication

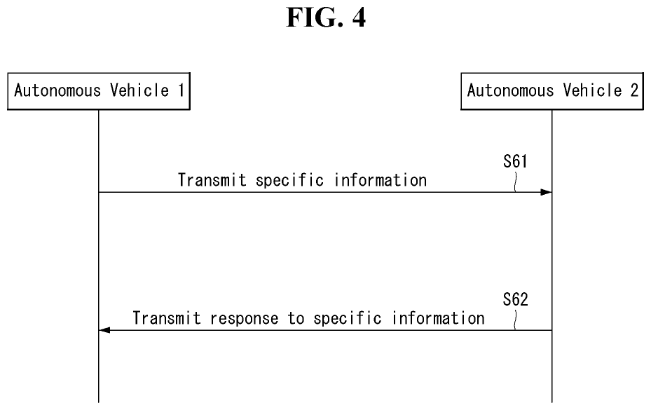

FIG. 4 shows an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (sidelink communication transmission mode 3) or indirectly (sidelink communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network may transmit DCI format 5A to the first vehicle for scheduling of mode-3 transmission (PSCCH and/or PSSCH transmission). Here, a physical sidelink control channel (PSCCH) is a 5G physical channel for scheduling of transmission of specific information a physical sidelink shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

The above-described 5G communication technology may be combined with methods proposed in the present disclosure which will be described later and applied or may complement the methods proposed in the present disclosure to make technical features of the methods concrete and clear.

Driving

(1) Exterior of Vehicle

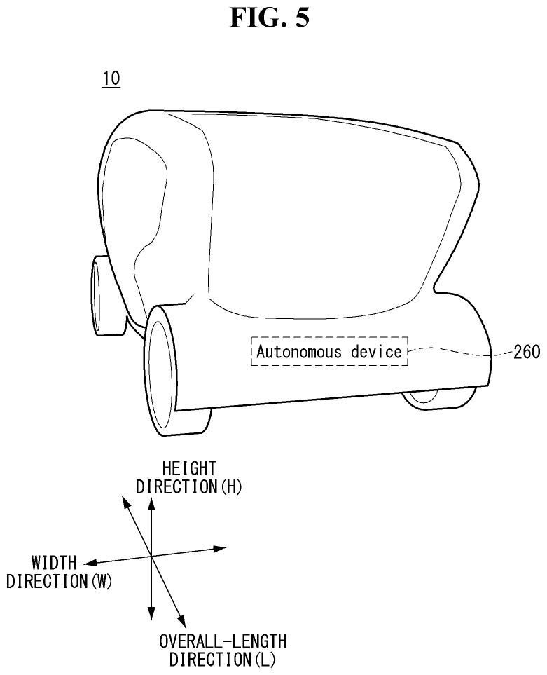

FIG. 5 is a diagram showing a vehicle according to an embodiment of the present disclosure.

Referring to FIG. 5, a vehicle 10 according to an embodiment of the present disclosure is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

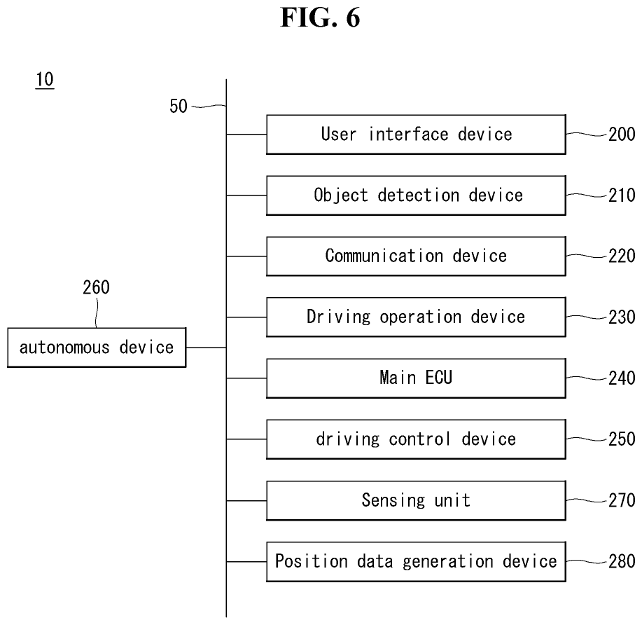

FIG. 6 is a control block diagram of the vehicle according to an embodiment of the present disclosure.

Referring to FIG. 6, the vehicle 10 may include a user interface device 200, an object detection device 210, a communication device 220, a driving operation device 230, a main ECU 240, a driving control device 250, an autonomous driving device 260, a sensing unit 270, and a position data generation device 280. The object detection device 210, the communication device 220, the driving operation device 230, the main ECU 240, the driving control device 250, the autonomous driving device 260, the sensing unit 270 and the position data generation device 280 may be realized by electronic devices which generate electric signals and exchange the electric signals from one another.

1) User Interface Device

The user interface device 200 is a device for communication between the vehicle 10 and a user. The user interface device 200 may receive user input and provide information generated in the vehicle 10 to the user. The vehicle 10 may realize a user interface (UI) or user experience (UX) through the user interface device 200. The user interface device 200 may include an input device, an output device and a user monitoring device.

2) Object Detection Device

The object detection device 210 may generate information about objects outside the vehicle 10. Information about an object may include at least one of information on presence or absence of the object, positional information of the object, information on a distance between the vehicle 10 and the object, and information on a relative speed of the vehicle 10 with respect to the object. The object detection device 210 may detect objects outside the vehicle 10. The object detection device 210 may include at least one sensor which may detect objects outside the vehicle 10. The object detection device 210 may include at least one of a camera, a radar, a lidar, an ultrasonic sensor and an infrared sensor. The object detection device 210 may provide data about an object generated on the basis of a sensing signal generated from a sensor to at least one electronic device included in the vehicle.

2.1) Camera

The camera may generate information about objects outside the vehicle 10 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera may obtain positional information of objects, information on distances to objects, or information on relative speeds with respect to objects using various image processing algorithms. For example, the camera may obtain information on a distance to an object and information on a relative speed with respect to the object from an obtained image on the basis of change in the size of the object over time. For example, the camera may obtain information on a distance to an object and information on a relative speed with respect to the object through a pin-hole model, road profiling, or the like. For example, the camera may obtain information on a distance to an object and information on a relative speed with respect to the object from a stereo image obtained from a stereo camera on the basis of disparity information.

The camera may be attached at a portion of the vehicle at which FOV (field of view) may be secured in order to photograph the outside of the vehicle. The camera may be disposed in proximity to the front windshield inside the vehicle in order to obtain front view images of the vehicle. The camera may be disposed near a front bumper or a radiator grill. The camera may be disposed in proximity to a rear glass inside the vehicle in order to obtain rear view images of the vehicle. The camera may be disposed near a rear bumper, a trunk or a tail gate. The camera may be disposed in proximity to at least one of side windows inside the vehicle in order to obtain side view images of the vehicle. Alternatively, the camera may be disposed near a side mirror, a fender or a door.

2.2) Radar

The radar may generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar may detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3) Lidar

The lidar may generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar may detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 may exchange signals with devices disposed outside the vehicle 10. The communication device 220 may exchange signals with at least one of infrastructure (e.g., a server and a broadcast station), another vehicle and a terminal. The communication device 220 may include a transmission antenna, a reception antenna, and at least one of a radio frequency (RF) circuit and an RF element which may implement various communication protocols in order to perform communication.

For example, the communication device may exchange signals with external devices on the basis of C-V2X (Cellular V2X). For example, C-V2X may include sidelink communication on the basis of LTE and/or sidelink communication on the basis of NR. Details related to C-V2X will be described later.

For example, the communication device may exchange signals with external devices on the basis of DSRC (Dedicated Short Range Communications) or WAVE (Wireless Access in Vehicular Environment) standards on the basis of IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that may use a frequency of 5.9 GHz and have a data transfer rate in the range of 3 Mbps to 27 Mbps. IEEE 802.11p may be combined with IEEE 1609 to support DSRC (or WAVE standards).

The communication device of the present disclosure may exchange signals with external devices using only one of C-V2X and DSRC. Alternatively, the communication device of the present disclosure may exchange signals with external devices using a hybrid of C-V2X and DSRC.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 may control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Controller)).

The driving control device 250 may control vehicle driving devices on the basis of signals received by the autonomous driving device 260. For example, the driving control device 250 may control a power train, a steering device and a brake device on the basis of signals received by the autonomous driving device 260.

7) Autonomous Device

The autonomous driving device 260 may generate a route for self-driving on the basis of obtained data. The autonomous driving device 260 may generate a driving plan for traveling along the generated route. The autonomous driving device 260 may generate a signal for controlling movement of the vehicle according to the driving plan. The autonomous driving device 260 may provide the signal to the driving control device 250.

The autonomous driving device 260 may implement at least one ADAS (Advanced Driver Assistance System) function. The ADAS may implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous driving device 260 may perform switching from a self-driving mode to a manual driving mode or switching from the manual driving mode to the self-driving mode. For example, the autonomous driving device 260 may switch the mode of the vehicle 10 from the self-driving mode to the manual driving mode or from the manual driving mode to the self-driving mode on the basis of a signal received from the user interface device 200.

8) Sensing Unit

The sensing unit 270 may detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 may generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Position Data Generation Device

The position data generation device 280 may generate position data of the vehicle 10. The position data generation device 280 may include at least one of a global positioning system (GPS) and a differential global positioning system (DGPS). The position data generation device 280 may generate position data of the vehicle 10 on the basis of a signal generated from at least one of the GPS and the DGPS. According to an embodiment, the position data generation device 280 may correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 may exchange signals through the internal communication system 50. The signals may include data. The internal communication system 50 may use at least one communication protocol (e.g., CAN, LIN, FlexRay, MOST or Ethernet).

(3) Components of Autonomous Device

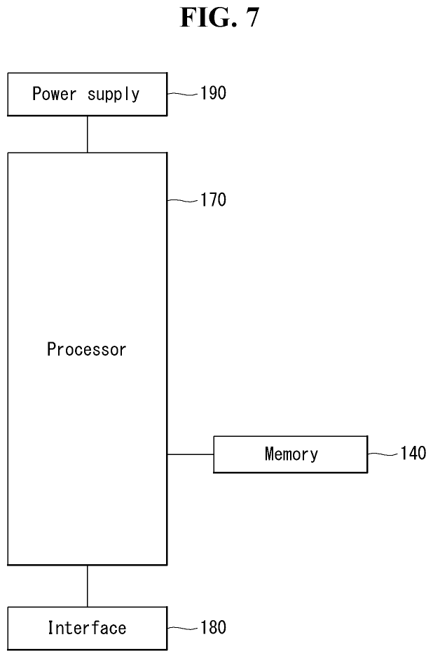

FIG. 7 is a control block diagram of the autonomous device according to an embodiment of the present disclosure.

Referring to FIG. 7, the autonomous driving device 260 may include a memory 140, a processor 170, an interface 180 and a power supply 190.

The memory 140 is electrically connected to the processor 170. The memory 140 may store basic data with respect to units, control data for operation control of units, and input/output data. The memory 140 may store data processed in the processor 170. Hardware-wise, the memory 140 may be configured as at least one of a ROM, a RAM, an EPROM, a flash drive and a hard drive. The memory 140 may store various types of data for overall operation of the autonomous driving device 260, such as a program for processing or control of the processor 170. The memory 140 may be integrated with the processor 170. According to an embodiment, the memory 140 may be categorized as a subcomponent of the processor 170.

The interface 180 may exchange signals with at least one electronic device included in the vehicle 10 in a wired or wireless manner. The interface 180 may exchange signals with at least one of the object detection device 210, the communication device 220, the driving operation device 230, the main ECU 240, the driving control device 250, the sensing unit 270 and the position data generation device 280 in a wired or wireless manner. The interface 180 may be configured using at least one of a communication module, a terminal, a pin, a cable, a port, a circuit, an element and a device.

The power supply 190 may provide power to the autonomous driving device 260. The power supply 190 may be provided with power from a power source (e.g., a battery) included in the vehicle 10 and supply the power to each unit of the autonomous driving device 260. The power supply 190 may operate according to a control signal supplied from the main ECU 240. The power supply 190 may include a switched-mode power supply (SMPS).

The processor 170 may be electrically connected to the memory 140, the interface 180 and the power supply 190 and exchange signals with these components. The processor 170 may be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 may be operated by power supplied from the power supply 190. The processor 170 may receive data, process the data, generate a signal and provide the signal while power is supplied thereto.

The processor 170 may receive information from other electronic devices included in the vehicle 10 through the interface 180. The processor 170 may provide control signals to other electronic devices in the vehicle 10 through the interface 180.

The autonomous driving device 260 may include at least one printed circuit board (PCB). The memory 140, the interface 180, the power supply 190 and the processor 170 may be electrically connected to the PCB.

(4) Operation of Autonomous Device

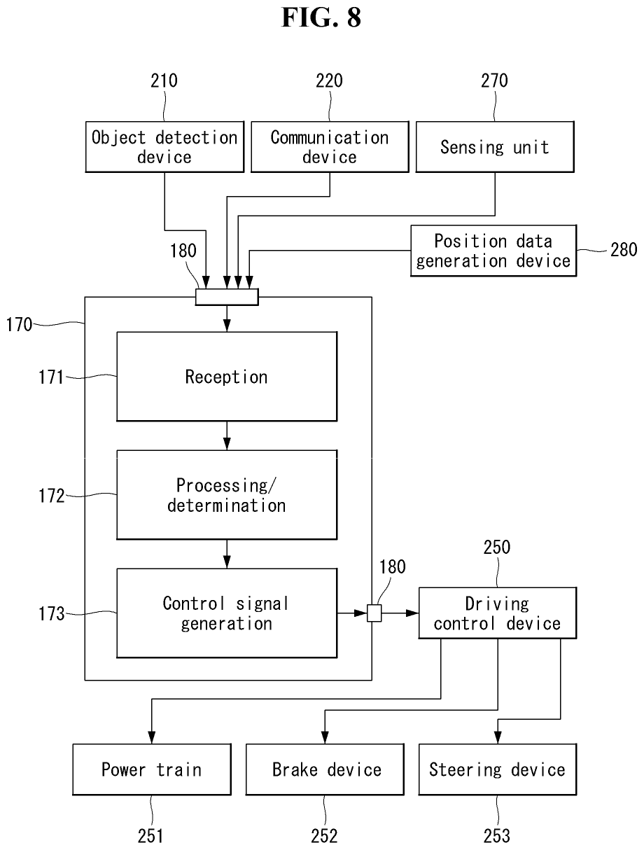

FIG. 8 is a diagram showing a signal flow in an autonomous vehicle according to an embodiment of the present disclosure.

1) Reception Operation

Referring to FIG. 8, the processor 170 may perform a reception operation. The processor 170 may receive data from at least one of the object detection device 210, the communication device 220, the sensing unit 270 and the position data generation device 280 through the interface 180. The processor 170 may receive object data from the object detection device 210. The processor 170 may receive HD map data from the communication device 220. The processor 170 may receive vehicle state data from the sensing unit 270. The processor 170 may receive position data from the position data generation device 280.

2) Processing/Determination Operation

The processor 170 may perform a processing/determination operation. The processor 170 may perform the processing/determination operation on the basis of traveling situation information. The processor 170 may perform the processing/determination operation on the basis of at least one of object data, HD map data, vehicle state data and position data.

2.1) Driving Plan Data Generation Operation

The processor 170 may generate driving plan data. For example, the processor 170 may generate electronic horizon data. The electronic horizon data may be understood as driving plan data in a range from a position at which the vehicle 10 is located to a horizon. The horizon may be understood as a point a predetermined distance before the position at which the vehicle 10 is located on the basis of a predetermined traveling route. The horizon may refer to a point at which the vehicle may arrive after a predetermined time from the position at which the vehicle 10 is located along a predetermined traveling route.

The electronic horizon data may include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be on the basis of data stored in at least one memory included in the vehicle 10.

The road data may include at least one of road slope data, road curvature data and road speed limit data. The road data may further include no-passing zone data. The road data may be on the basis of data received from an external server through the communication device 220. The road data may be on the basis of data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be on the basis of data received from an external server through the communication device 220.

The dynamic data may include various types of dynamic information which may be generated on roads. For example, the dynamic data may include construction information, variable speed road information, road condition information, traffic information, moving object information, etc. The dynamic data may be on the basis of data received from an external server through the communication device 220. The dynamic data may be on the basis of data generated in the object detection device 210.

The processor 170 may provide map data in a range from a position at which the vehicle 10 is located to the horizon.

2.1.2) Horizon Path Data

The horizon path data may be explained as a trajectory through which the vehicle 10 may travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road may be calculated to be higher than a probability of selecting the second road.

The horizon path data may include a main path and a sub-path. The main path may be understood as a trajectory obtained by connecting roads having a high relative probability of being selected. The sub-path may be branched from at least one decision point on the main path. The sub-path may be understood as a trajectory obtained by connecting at least one road having a low relative probability of being selected at at least one decision point on the main path.

3) Control Signal Generation Operation

The processor 170 may perform a control signal generation operation. The processor 170 may generate a control signal on the basis of the electronic horizon data. For example, the processor 170 may generate at least one of a power train control signal, a brake device control signal and a steering device control signal on the basis of the electronic horizon data.

The processor 170 may transmit the generated control signal to the driving control device 250 through the interface 180. The driving control device 250 may transmit the control signal to at least one of a power train 251, a brake device 252 and a steering device 254.

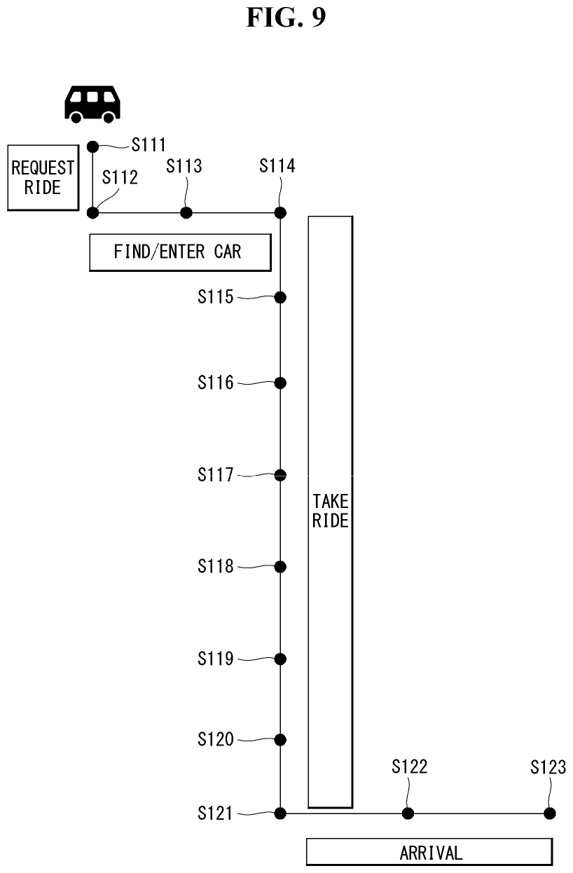

FIG. 9 is a diagram referred to for describing a usage scenario of a user according to an embodiment of the present disclosure.

1) Destination Prediction Scenario

An autonomous vehicle may include a cabin system. In the following, the cabin system may be interpreted as a traveling vehicle. A first scenario S111 is a scenario for predicting a destination of a user. A user terminal may install an application interoperable with the cabin system. The user terminal, through the application, may predict a destination of the user on the basis of user's contextual information. The user terminal may provide vacancy information in a cabin through the application.

2) Cabin Interior Layout Preparation Scenario

A second scenario S112 is a cabin interior layout preparation scenario. The cabin system may further include a scanning device for obtaining data about a user located outside the vehicle. The scanning device may obtain the user's body data and baggage data by scanning the user. The user's body data and baggage data may be used to set a layout. The user's body data may be used for user authentication. The scanning device may include at least one image sensor. The image sensor may obtain a user image using light of a visible light band or an infrared band.

The cabin system may include a seat system. The seat system may set a layout in the cabin on the basis of at least one of the user's body data and baggage data. For example, the seat system may provide a baggage storage space or a car seat installation space.

3) User Welcome Scenario

A third scenario S113 is a user welcome scenario. The cabin system may further include at least one guide light. The guide light may be disposed on the floor in the cabin. When it is detected that the user gets on the vehicle, the cabin system may output the guide light so that the user may sit on a predetermined seat among a plurality of seats. For example, a main controller of the cabin system may implement moving light by sequentially turning on a plurality of light sources over time from an open door to the predetermined user seat.

4) Seat Adjustment Service Scenario

A fourth scenario S114 is a seat adjustment service scenario. The seat system may adjust at least one element of the seat that matches the user on the basis of obtained body information.

5) Personal Content Scenario

A fifth scenario S115 is a personal content providing scenario. A display system of the cabin system may receive user personal data via an input device or a communication device. The display system may provide content corresponding to user personal data.

6) Product Providing Scenario

A sixth scenario S116 is a product providing scenario. The cabin system may further comprise a cargo system. The cargo system may receive user data via the input device or the communication device. The user data may include preference data of the user, destination data of the user, and the like. The cargo system may provide goods on the basis of the user data.

7) Payment Scenario

A seventh scenario S117 is a payment scenario. The cabin system may further include a payment system. The payment system may receive data for estimating cost from at least one of the input device, the communication device, and the cargo system. The payment system may estimate cost for using a vehicle of the user on the basis of the received data. The payment system may request a payment from a user (e.g., a user's mobile terminal) at an estimated cost.

8) User's Display System Control Scenario

An eighth scenario S118 is a user's display system control scenario. The input device of the cabin system may receive a user input of at least one type and convert the user input into an electrical signal. The display system may control displayed content on the basis of the electrical signal.

9) Al Agent Scenario

The main controller of the cabin system may include an artificial intelligence (Al) agent. The Al agent may perform machine learning on the basis of data obtained through the input device. The Al agent may control at least one of the display system, the cargo system, the seat system, and the payment system on the basis of results of machine learning.

A ninth scenario S119 is a multi-channel Al agent scenario for multiple users. The Al agent may classify user inputs of the multiple users. The Al agent may control at least one of the display system, the cargo system, the seat system, and the payment system on the basis of an electrical signal converted from individual user inputs of the multiple users.

10) Scenario for Providing Multimedia Content for Multiple Users

A tenth scenario S120 is a scenario for providing multimedia content for multiple users. The display system may provide content that all users may watch together. In this case, the display system may provide the same sound to the multiple users individually through a speaker provided for each sheet. The display system may provide content that multiple users may watch individually. In this case, the display system may provide an individual sound through the speaker provided for each sheet.

11) User Safety Ensuring Scenario

An eleventh scenario S121 is a scenario for ensuring user safety. In the case of obtaining information on an object around the vehicle that threatens a user, the main controller may control an alarm for the object around the vehicle to be output through the display system.

12) Scenarios for Preventing Loss of Belongings

A twelfth scenario S122 is a scenario for preventing loss of personal belongings of the user. The main controller may obtain data on belongings of the user through the input device. The main controller may obtain motion data of the user through the input device. The main controller may determine whether the user gets off with the belongings left behind on the basis of the data on the belongings and the motion data. The main controller may control an alarm related to the belongings to be output through the display system.

13) Get-Off Report Scenario

A thirteenth scenario S123 is a get-off report scenario. The main controller may receive get-off data of the user through the input device. After the user gets off the vehicle, the main controller may provide report data according to getting off to the user's mobile terminal through the communication device. The report data may include total usage fee data of the vehicle 10.

V2X (Vehicle-to-Everything)

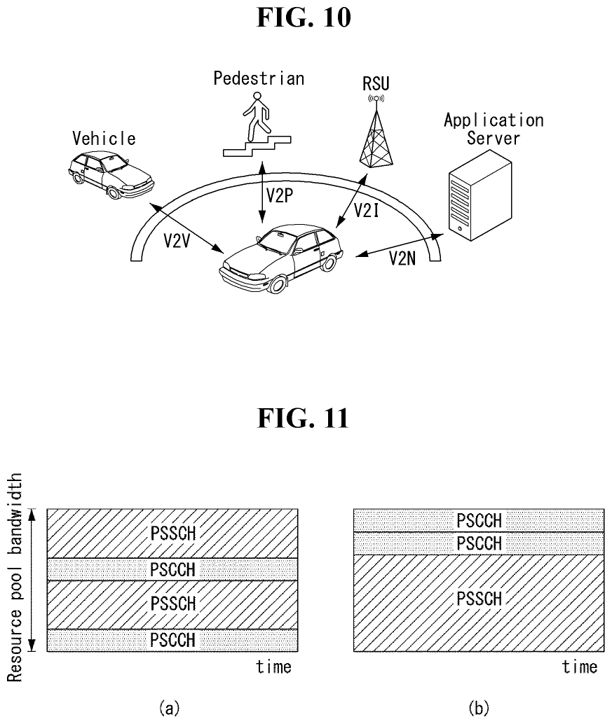

FIG. 10 illustrates V2X communication to which the present disclosure may be applied.

V2X communication refers to communication between a vehicle and any entity, such as a vehicle-to-vehicle (V2V) that refers to communication between vehicles, a vehicle to infrastructure (V2I) that refers to communication between a vehicle and an eNB or a road side unit (RSU), a vehicle-to-pedestrian (V2P) and vehicle-to-network (V2N) which refer to communication between the vehicle and a UE carried by an individual (pedestrian, bicyclist, driver or passenger).

The V2X communication may have the same meaning as the V2X sidelink or the NR V2X or may have a broader meaning including the V2X sidelink or the NR V2X.

V2X communications may be applied to various services such as forward collision warning, automatic parking system, cooperative adaptive cruise control (CACC), loss of control warning, traffic queue warning, traffic vulnerable safety warning, emergency vehicle warning, speed warning when driving a bend in the road, traffic flow control.

V2X communication may be provided through a PC5 interface and/or a Uu interface. In this case, in a wireless communication system supporting V2X communication, specific network entities may exist for supporting communication between the vehicle and all entities. For example, the network entity may be a BS (eNB), a road side unit (RSU), a UE, or an application server (e.g., a traffic safety server).

In addition, the UE performing V2X communication may refer to not only a general handheld UE but also a vehicle UE (V-UE), a pedestrian UE, a BS (eNB) type RSU, a UE type RSU, a robot having a communication module, and the like.

V2X communication may be performed directly between UEs or may be performed through a network entity(s). A V2X operation mode may be classified according to a method of performing the V2X communication.

V2X communication is required to support pseudonymity and privacy of a UE at the time of using a V2X application so that an operator or a third party cannot track a UE identifier within an area where the V2X is supported.

Terms used frequently in V2X communication are defined as follows.
Road side unit (RSU): An RSU is a V2X serviceable device that may transmit/receive a signal to and from a moving vehicle using a V2I service. In addition, the RSU is a fixed infrastructure entity that supports a V2X application and may exchange messages with other entities that support the V2X application. The RSU is a commonly used term in the existing ITS specification, and the reason for introducing the term to the 3GPP specification is to make document easier to read in an ITS industry. The RSU is a logical entity that combines a V2X application logic with a function of a BS (called a BS-type RSU) or a UE (called a UE-type RSU).
V2I service: A type of V2X service in which one side is a vehicle and the other side is an entity that belongs to an infrastructure.
V2P service: A type of V2X service in which one side is a vehicle and the other side is a device carried by an individual (e.g., a portable UE device carried by a pedestrian, cyclist, driver, or passenger).
V2X service: A type of 3GPP communication service associated with a transmitting or receiving device in a vehicle.
V2X enabled UE: UE supporting a V2X service.
V2V service: A type of V2X service, both sides of communication are vehicles.
V2V communication range: A direct communication range between two vehicles participating in a V2V service.

The V2X application called vehicle-to-everything (V2X) includes four types of (1) vehicle-to-vehicle (V2V), (2) vehicle-to-infrastructure (V2I), (3) vehicle-to-network (V2N), and (4) vehicle-to-pedestrian (V2P) as described above.

FIG. 11 illustrates a method of allocating resources in a sidelink in which V2X is used.

In a sidelink, different sidelink control channels (PSCCHs) are allocated to be spaced apart from each other in a frequency domain and different sidelink shared channels (PSSCHs) may be allocated to be spaced apart from each other as shown in

FIG. 11A. may be allocated spaced apart. Alternatively, different PSCCHs may be contiguously allocated in the frequency domain and PSSCHs may also be allocated contiguously in the frequency domain as shown in FIG. 11B.

NR V2X

Support for V2V and V2X services in LTE was introduced to extend a 3GPP platform to an automotive industry during 3GPP releases 14 and 15.

Requirements for supporting the enhanced V2X use case are classified into four use case groups.

(1) Vehicle platooning enables vehicles to dynamically form a platoon to move together. All the vehicles of the platoon obtains information from a leading vehicle to manage the platoon. Such information allows the vehicles to drive in a more harmoniously, go in the same direction, and drive together.

(2) Extended sensors allows a vehicle, a road side unit, a pedestrian device, and a V2X application server to exchange raw data collected through a local sensor or live video image or processed data. Vehicles may raise environmental awareness beyond what their sensors may detect and may extensively or collectively recognize a local situation. A high data rate is one of the main features.

(3) Advanced driving enables semi-automatic or fully-automatic driving. Each vehicle and/or RSU shares its self-aware data obtained from a local sensor with nearby vehicles and allows a vehicle to synchronize and coordinate trajectory or maneuver. Each vehicle shares a driving intent with a nearby driving vehicle.

(4) Remote driving allows a remote driver or V2X application to drive a remote vehicle for a passenger who is unable to drive on their own or in a remote vehicle in a dangerous environment. If fluctuations are limited and a route may be predicted like public transportation, driving based on cloud computing may be used. High reliability and low latency are key requirements.

The 5G communication technology described above may be applied in combination with the methods proposed herein or may be supplemented to specify or clarify the technical features of the methods proposed herein.

Hereinafter, a lidar system and an autonomous driving system using the same according to an embodiment of the present disclosure will be described in detail. In the lidar system of the present disclosure, one or more of an autonomous vehicle, an Al device, and an external device may be associated with an Al module, an unmanned aerial vehicle (UAV), a robot, an augmented reality (AR) device, a virtual reality (VR) device, a device related to a 5G network service, and the like. In the following, an embodiment is described based on an example where the lidar system is applied to an autonomous vehicle but it should be noted that the present disclosure is not limited thereto.

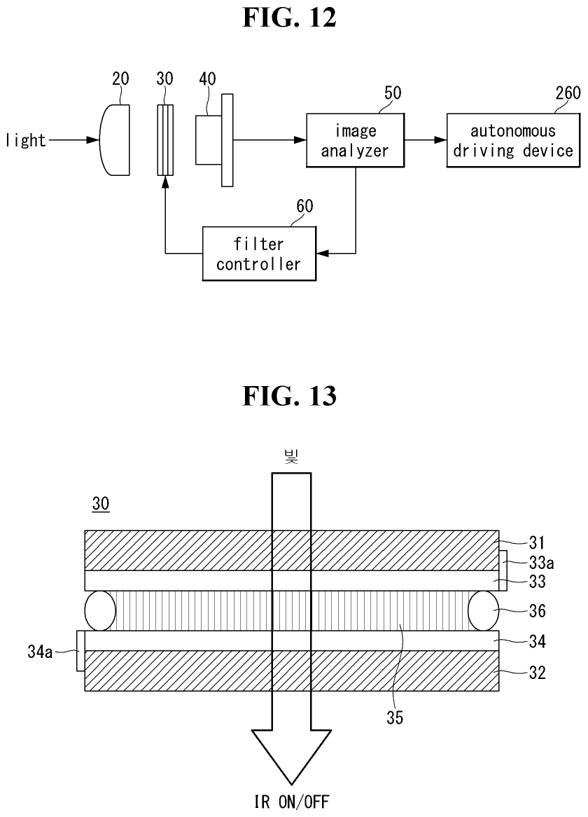

The object detection device 210 may include a camera as shown in FIG. 12.

FIG. 12 is a block diagram illustrating a configuration of a camera according to an embodiment of the present disclosure.

Referring to FIG. 12, the camera includes an active filter 30, an image sensor 40, an image analyzer 50, and a filter controller 60.

The active filter 30 selectively allows light having an infrared (IR) wavelength to pass therethrough or and blocks the light under the control of the filter controller 60. A lens 20 may be disposed in front of a light incident surface of the active filter 30. The lens 20 collects light that travels to the active filter 30. The active filter 30 allows light having a specific wavelength band to pass through the image sensor 40 when operating in a pass mode under the control of the filter controller 60, and blocks the light having the specific wavelength band that travels to the image sensor 40 when operating in a blocking mode. The specific wavelength band may be an infrared wavelength band IR or a visible light wavelength band RGB.

The image sensor 30 includes a plurality of pixels that convert light from the active filter 30 into an electrical signal. Each of the pixels may include a photo sensor such as a photodiode. The image sensor 30 outputs an image signal of an external environment viewed by the camera.

The image analyzer 40 analyzes an image signal obtained from the image sensor 30, detects surrounding objects such as a nearby vehicle, person, object, road, sign, and the like and transmits the detected objects to the autonomous driving device 260. The autonomous driving device 260 reflects the surrounding object information detected by the camera in driving of the vehicle 10.

In addition, the image analyzer 40 generates a histogram for each wavelength of the input image every frame and provides a result of the histogram analysis to the filter controller 60.

The filter controller 60 controls the active filter 60 on the basis of the result of the histogram analysis of each wavelength of the input image. For example, when a proportion of pixels receiving light having an infrared wavelength band IR is smaller than a predetermined value as the result of the histogram analysis for each wavelength, the filter controller 60 controls the active filter 30 such that light having a visible light wavelength band RGB is transmitted to the image sensor 40. When a proportion of pixels receiving light having an infrared wavelength band IR is equal to or larger than the predetermined value as the result of the histogram analysis for each wavelength, the filter controller 60 controls the active filter 30 such that light having the infrared wavelength band IR is transmitted to the image sensor 40. Therefore, the filter controller 60 selects the wavelength of light passing through the active filter on the basis of the analysis result of the image signal obtained from the image sensor 40.

The image analyzer 50 and the filter controller 60 may be implemented by a DSP including an ISP.

FIG. 13 is a cross-sectional view illustrating an example of an active filter according to an embodiment of the present disclosure.

Referring to FIG. 13, the active filter 31 includes first and second transparent substrates 31 and 32 facing each other with a wavelength selective material layer 35 interposed therebetween.

First and second transparent substrates 31 and 32 include transparent electrodes 33 and 34 such as indium tin oxide (ITO) for applying an electric field to the wavelength selective material layer 35, respectively. The first transparent electrode 33 is connected to the filter controller 40 through the external electrode 33a. The second transparent electrode 34 is connected to the filter controller 40 through an external electrode 33a.

The first and second transparent substrates 31 and 32 are bonded through a sealant or spacer 36 to define the wavelength selective material layer 35.

The wavelength selective material layer 35 includes an infrared ray blocking material in a liquid state. In addition, the wavelength selective material layer 35 may further include a visible light blocking material in a liquid state. The infrared blocking material includes molecules that reflect or absorb light having the infrared wavelength band that reacts according to an electric field. The visible light blocking material includes molecules that reflect or absorb light having a visible light wavelength band which reacts according to an electric field. The infrared blocking material and the visible light blocking material may be selected from known materials. Infrared blocking material and the visible light blocking material may reflect or absorb light having a specific wavelength.

The filter controller 60 selects a wavelength of light passing through the active filter 30 by switching a driving signal applied to the active filter 30 every frame according to a result of analyzing an image obtained from the image sensor 42.

The filter controller 60 does not output the driving signal as a deactivation voltage or apply the driving signal to the active filter 30 in the blocking mode. In this case, the active filter 30 is deactivated to block light having the infrared wavelength band IR to allow only light having the visible light wavelength band RGB to pass therethrough.

The filter controller 60 outputs the driving signal as an activation voltage in the pass mode and applies the driving signal to the electrodes 33 and 34 of the active filter 30. In this case, the active filter 30 may be activated to allow only light having the infrared wavelength band IR to pass therethrough.

The active filter 30 is implemented as a dual band pass filter including a first active filter allowing light having the infrared wavelength band to pass therethrough or blocking the light and a second active filter allowing light having the visible light wavelength band RGB to pass therethrough or blocking the light. Each of the first and second active filters may be individually controlled by the filter controller 60.

Since the active filter 30 does not have a polarizing plate, there is no loss of light loss due to the polarizing plate.

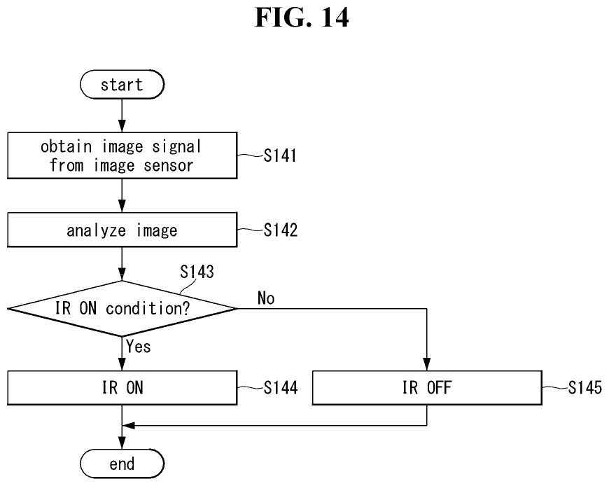

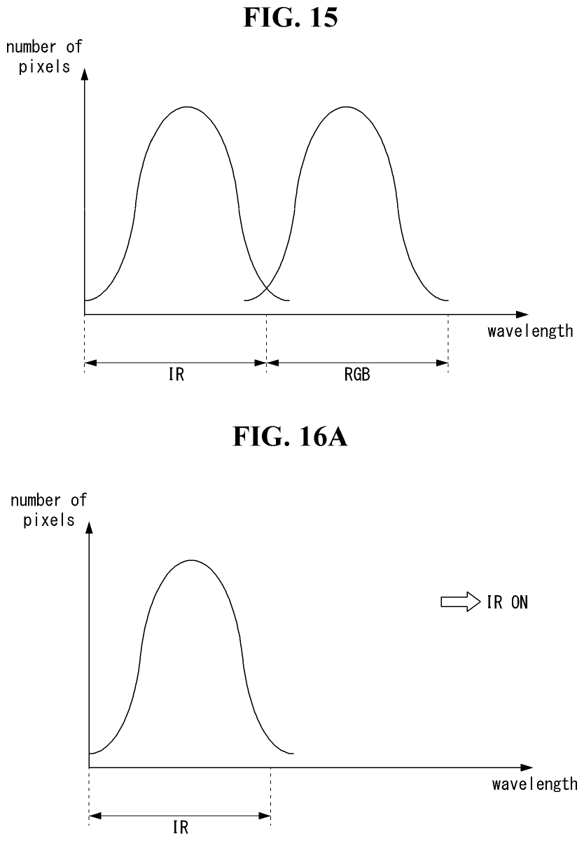

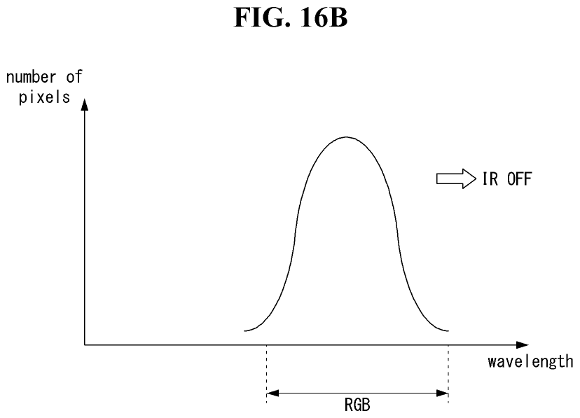

FIG. 14 is a diagram illustrating a method of controlling an active filter. FIG. 15 shows a histogram of an IR wavelength band and a visible light wavelength band. FIG. 16A shows an example of a histogram showing a pass mode of an active filter. FIG. 16B shows an example of a histogram showing a blocking mode of an active filter.

Referring to FIGS. 14 to 16A, light received by the camera may include light having the visible light wavelength band RGB and light having the infrared wavelength band IR. In a dark environment such as at night or in a tunnel, light received by the camera may be reduced in the amount of light having the visible light wavelength band RGB and may be increased in the amount of light having the infrared wavelength band IR relatively. In a bright environment, light received by the camera may be increased in the amount of light having the visible light wavelength band RGB and may be reduced in the amount of light having the infrared wavelength band IR relatively.

The camera of the present disclosure activates the active filter 30 in a dark environment to allow only light having the infrared wavelength band IR to pass therethrough to improve image quality of an image signal output from the image sensor 40 in the dark environment and increase an object recognition rate of the image signal. The dark environment may be a pass mode in which the amount of light having the visible light wavelength band received by the image sensor is small.

The camera of the present disclosure deactivates the active filter 30 in a bright environment and provides only light having the visible light wavelength band IR to the image sensor 40 to improve image quality of the image signal output from the image sensor 40 without saturation of light in the bright environment and increase an object recognition rate of the image signal. The bright environment may be a blocking mode in which the amount of light having the visible light wavelength band received by the image sensor is large.

The histogram for each wavelength of the input image obtained from the image sensor 40 shows a cumulative number of pixels that receive light having the infrared wavelength band IR and a cumulative number of pixels that receive light having the visible light wavelength band IR as shown in FIGS. 15 to 16B.

As a result of analyzing the image signals obtained from the image sensor 40 (S141 and S142), the active filter 30 may operate in the pass mode (IR ON) when the number of pixels that receive light having the infrared wavelength band IR among the pixels of the image sensor 40 is equal to or greater than a predetermined proportion, e.g., 60% or more, of the total pixels as shown in FIG. 16A (S143). In this case, the active filter 30 allows only the light having the infrared wavelength band IR to pass therethrough (S144). Here, the light having the visible light wavelength band RGB may be blocked by the active filter 30.

As a result of analysis of the image signal obtained from the image sensor 40 (S141 and S142), the active filter 30 may operate in the blocking mode (IR OFF) when the number of pixels that receive light having the visible light wavelength band RGB among the pixels of the image sensor 40 is equal to or greater than a predetermined proportion, e.g., 60% or more, of the total pixels as shown in FIG. 16B (S143). In this case, the active filter 30 may block the light having the infrared wavelength band IR and allow only the light having the visible light wavelength band RGB to pass therethrough (S145).

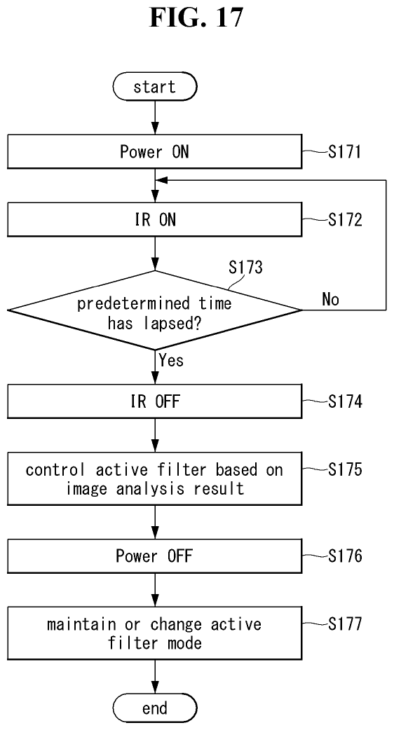

FIG. 17 is a flowchart illustrating a method of controlling an active filter in a time flow from starting of a vehicle to turning off a vehicle power.

Referring to FIG. 17, when a vehicle 10 is powered on and started, power is applied to the camera so that the image sensor 40, the image analyzer 50, the filter controller 60, and the active filter 30 are started to be driven. The active filter 30 may allow only light having the infrared wavelength band IR to pass therethrough under the control of the filter controller 60 for a predetermined time from a time point when the power was applied to the camera at the start of the vehicle 10, for example, from 0 to 3 seconds immediately after the start of the vehicle 10 (S171 to S173). Here, the autonomous driving device 260 may process user authentication of the driver or passenger in the vehicle 10 on the basis of the image signal received from the camera.

When the predetermined time has elapsed since the vehicle 10 was started, the active filter 30 blocks the light having the infrared wavelength band IR under the control of the filter controller 60 to provide light having the visible light wavelength band RGB to the image sensor 40 (S174). When the predetermined time has elapsed since the vehicle 10 was started, the vehicle 10 may be driving. During this time, the camera may operate in a video stream mode or in a monitoring mode to monitor a state of the driver and the passenger to provide a real-time image signal to the autonomous vehicle 260 and provide a change in the state of the driver and the passenger. In addition, the camera may operate in a selfie mode when the predetermined time has lapsed since the vehicle 10 was started.

When a dark environment is determined, that is, when the pass mode (IR ON) is determined, based on a result of analyzing the image signal obtained from the image sensor, the filter controller 60 may activate the active filter 30 and provide only light having the infrared wavelength band IR to the image sensor (S175). When a bright environment is determined, that is, when the blocking mode (IR OFF) is determined, based on the result of analyzing the image signal obtained from the image sensor, the filter controller 60 may deactivate the active filter 30 and provide only light having the visible light wavelength band RGB to the image sensor (S175).

Accordingly, the wavelength of light provided to the image sensor IR may be varied in real time according to a surrounding environment of the vehicle during driving of the vehicle 10. When a distribution of a cumulative number of pixels for each wavelength of the histogram for each wavelength of the image signal obtained from the image sensor 40 is changed after the lapse of the predetermined time since the power was applied to the camera, the filter controller 60 may vary a mode of the active filter in real time.

When the power of the camera is cut off, an operation mode of the active filter may be maintained as a last mode or changed to a default setting mode. The default setting mode may be the pass mode or the blocking mode.

In the histogram for each wavelength, the cumulative number of pixels for each wavelength may be repeatedly shifted within a short time at a boundary between the infrared wavelength band and the visible light wavelength band. In this case, the filter controller 60 may determine that the camera is malfunctioning and may fix the operation mode of the active filter for a preset holding time or control the operation mode of the active filter on the basis of information received through a V2X communication network.

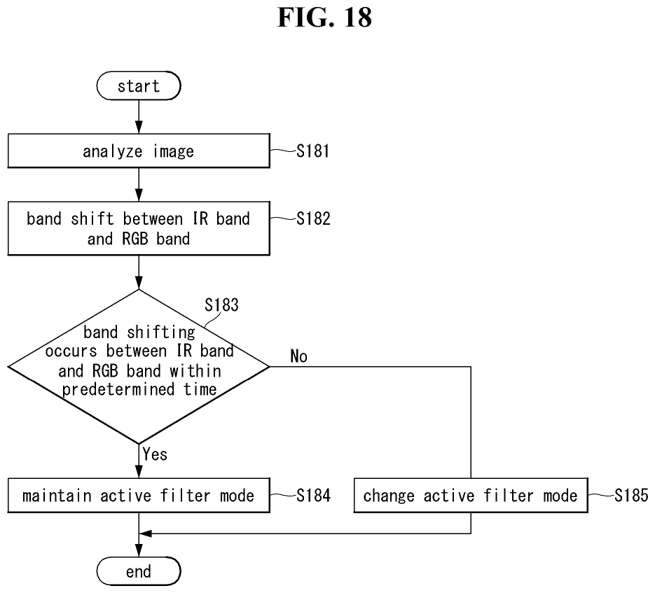

FIG. 18 is a flowchart illustrating an example of a method of controlling an active filter when a pass mode and a blocking mode are repeatedly changed within a predetermined time.

Referring to FIG. 18, the filter controller 60 may control an operation mode of the active filter 30 on the basis of a result of a histogram analysis for each wavelength of an image signal obtained from the image sensor 40. However, due to a malfunction of the image analyzer 50 or an external impact, the cumulative pixel number shifting may occur within a predetermined time, for example, within a few microseconds between the infrared wavelength band and the visible light wavelength band in the histogram for each wavelength (S181 and S182). In this case, the active filter 30 may be quickly changed in operation mode within a short time between the pass mode and the blocking mode, which may degrade image quality and make it difficult to detect an object of the image signal.

In order to prevent such a malfunction, when the cumulative pixel number shifting occurs within a predetermined time between the infrared wavelength band and the visible light wavelength band in the histogram for each wavelength of the image signal obtained from the image sensor 40, the filter controller 60 may maintain the operation mode of the active filter 30 in the current mode for a predetermined holding time (S183 and S184). The holding time may be set to 30 sec, but is not limited thereto. If the cumulative pixel number shifting between the infrared wavelength band and the visible light wavelength band occurs after the predetermined time, the filter controller 60 may determine that the driving state is a normal driving state and change the operation mode of the active filter 30 (S183 and S185).

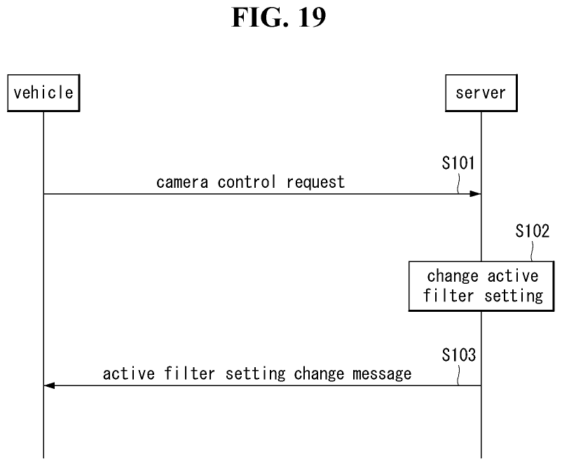

FIG. 19 is a diagram illustrating an example of a process of transmitting and receiving a signal for a camera control request through V2X communication.

Referring to FIG. 19, when a camera malfunction is inferred, the autonomous driving device 260 may transmit a camera control request message to a server or a nearby vehicle through V2X communication (S101).

The server may determine an environment of a driving route of the vehicle and change a setting value of the active filter (S102). For example, the server may receive current position information of the vehicle from the autonomous driving device on the driving route and change the setting value of the active filter to the pass mode if a surrounding environment is dark or is a tunnel at the current position, and transmits an active filter setting change message to the vehicle 10 to control the active filter 30 in the pass mode (S102 and S103). In addition, if the surrounding environment of the vehicle is bright, the server may change the setting value of the active filter to the blocking mode to control the active filter 30 in the blocking mode.

In the case of a nearby vehicle receiving the camera control request message, the nearby vehicle may transmit an image signal obtained from the image sensor 40 of the camera mounted on the own vehicle to the vehicle 10 requesting the camera control. In this case, the filter controller 60 of the vehicle 10 may control the operation mode of the active filter 30 on the basis of the histogram for each wavelength of the image signal received from the nearby vehicle.

Various embodiments of the image sensor system of the present disclosure are described as follows.

### Embodiment 1

An image sensor system includes: an active filter electrically controlled to allow light having an infrared wavelength to pass therethrough and block the light having the infrared wavelength; an image sensor converting light passing through the active filter into an electrical signal and outputting an image signal; an image analyzer analyzing the image signal obtained from the image sensor; and a filter controller selecting a wavelength of light passing through the active filter by electrically controlling an operation mode of the active filter on the basis of a result of analyzing the image signal.

The active filter may allow light having a specific wavelength band to pass through the image sensor when operating in a pass mode and block the light having the specific wavelength band when operating in a blocking mode.

### Embodiment 2

The light having an infrared wavelength band may pass through the image sensor via the active filter and light having a visible light wavelength band is blocked in the pass mode.

### Embodiment 3

The active filter may operate in the pass mode for a predetermined time immediately after power is applied to the active filter, the image sensor, the image analyzer, and the filter controller.

### Embodiment 4

The active filter may operate in the blocking mode after the lapse of the predetermined time.

### Embodiment 5

The filter controller may switch the active filter to the pass mode or the blocking mode on the basis of the result of analyzing the image signal obtained from the image sensor after the lapse of the predetermined time.

### Embodiment 6

The image analyzer may generate a histogram for each wavelength of the image signal obtained from the image sensor, and the filter controller may vary the mode of the active filter in real time when a distribution of a cumulative number of pixels for each wavelength of the histogram for each wavelength of the image signal obtained from the image sensor is changed after the lapse of the predetermined time.

### Embodiment 7

The image analyzer may generate a histogram for each wavelength of the image signal obtained from the image sensor, and the filter controller may control the active filter in the pass mode if the number of pixels receiving light having the infrared wavelength band, among pixels of the image sensor, is equal to or greater than a predetermined proportion to the entire pixels based on the histogram for each wavelength, and the filter controller may control the active filter in the blocking mode if the number of pixels receiving light having the visible light wavelength band, among the pixels of the image sensor, is equal to or greater than the predetermined proportion to the entire pixels based on the histogram for each wavelength.

### Embodiment 8

The filter controller may maintain an operation mode of the active filter in a current mode for a predetermined holding time if cumulative pixel number shifting occurs between the infrared wavelength band and the visible light wavelength band in the histogram for each wavelength within a predetermined time.

### Embodiment 9

The filter controller may switch the operation mode of the active filter in response to an active filter setting change message received from an external server through V2X communication.

### Embodiment 10

The image analyzer may generate a histogram for each wavelength of an image signal output from another image sensor received through V2X communication, and the filter controller may control the operation mode of the active filter on the basis of the histogram for each wavelength of the image signal output from the other image sensor.

Hereinafter, various embodiments of the autonomous driving system of the present specification will be described.

### Embodiment 1

An autonomous driving system includes: a camera outputting an image signal and detecting an object from the image signal; and an autonomous driving device reflecting the object information detected by the camera in driving of a vehicle.

The camera includes: an active filter electrically controlled to allow light having an infrared wavelength to pass therethrough and block the light having the infrared wavelength; an image sensor converting light passing through the active filter into an electrical signal and outputting an image signal; an image analyzer analyzing the image signal obtained from the image sensor; and a filter controller selecting a wavelength of light passing through the active filter by electrically controlling an operation mode of the active filter on the basis of a result of analyzing the image signal.

The active filter may allow light having a specific wavelength band to pass through the image sensor when operating in a pass mode and block the light having the specific wavelength band when operating in a blocking mode.

### Embodiment 2

The active filter, which allows the light having the infrared wavelength band to pass through the image sensor and blocks light having a visible light wavelength band in the pass mode, may block the light having the visible light wavelength band in the pass mode under the control of the filter controller.

### Embodiment 3

The active filter may operate in the pass mode for a predetermined time immediately after power is applied to the active filter, the image sensor, the image analyzer, and the filter controller.

### Embodiment 4

The active filter may operate in the blocking mode after the lapse of the predetermined time.

### Embodiment 5

The filter controller may switch the active filter to the pass mode or the blocking mode on the basis of the result of analyzing the image signal obtained from the image sensor after the lapse of the predetermined time.

### Embodiment 6

The image analyzer may generate a histogram for each wavelength of the image signal obtained from the image sensor, and the filter controller may vary the mode of the active filter in real time when a distribution of a cumulative number of pixels for each wavelength of the histogram for each wavelength of the image signal obtained from the image sensor is changed after the lapse of the predetermined time.

### Embodiment 7

The image analyzer may generate a histogram for each wavelength of the image signal obtained from the image sensor, and the filter controller may control the active filter in the pass mode if the number of pixels receiving light having the infrared wavelength band, among pixels of the image sensor, is equal to or greater than a predetermined proportion to the entire pixels based on the histogram for each wavelength, and the filter controller may control the active filter in the blocking mode if the number of pixels receiving light having the visible light wavelength band, among the pixels of the image sensor, is equal to or greater than the predetermined proportion to the entire pixels based on the histogram for each wavelength.

### Embodiment 8

The filter controller may maintain an operation mode of the active filter in a current mode for a predetermined holding time if cumulative pixel number shifting occurs between the infrared wavelength band and the visible light wavelength band in the histogram for each wavelength within a predetermined time.

### Embodiment 9

The filter controller may switch the operation mode of the active filter in response to an active filter setting change message received from an external server through V2X communication.

The effects of the camera according to the embodiments of the present disclosure will be described below.

The camera of the present disclosure may increase transmittance and simplify a system configuration by controlling the active filter without a polarizing plate based on the result of analyzing an image signal obtained from the image sensor.

The camera of the present disclosure improves image quality of the image signal output from the image sensor without saturation of light and increase an object recognition rate of the image signal in any environment by controlling the active filter in the pass mode or the blocking mode based on the result of analyzing the image signal obtained from the image sensor.

The present disclosure may be achieved as computer-readable codes on a program-recoded medium. A computer-readable medium includes all kinds of recording devices that keep data that may be read by a computer system. For example, the computer-readable medium may be an HDD (Hard Disk Drive), an SSD (Solid State Disk), an SDD (Silicon Disk Drive), a ROM, a RAM, a CD-ROM, a magnetic tape, a floppy disk, and an optical data storage, and may also be implemented in a carrier wave type (for example, transmission using the internet). Accordingly, the detailed description should not be construed as being limited in all respects and should be construed as an example. The scope of the present disclosure should be determined by reasonable analysis of the claims and all changes within an equivalent range of the present disclosure is included in the scope of the present disclosure.

Although embodiments have been described with reference to a number of illustrative embodiments thereof, it should be understood that numerous other modifications and embodiments may be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An image sensor system comprising:
an active filter electrically controlled to allow light having an infrared wavelength to pass therethrough and block the light having the infrared wavelength;
an image sensor converting light passing through the active filter into an electrical signal and outputting an image signal;
an image analyzer analyzing the image signal obtained from the image sensor; and
a filter controller selecting a wavelength of light passing through the active filter by electrically controlling an operation mode of the active filter on the basis of a result of analyzing the image signal,
wherein the active filter allows light having a specific wavelength band to pass through the image sensor when operating in a pass mode and blocks the light having the specific wavelength band when operating in a blocking mode.

2. The image sensor system of claim 1, wherein
light having an infrared wavelength band passes through the image sensor via the active filter and light having a visible light wavelength band is blocked in the pass mode.

3. The image sensor system of claim 1, wherein
the active filter operates in the pass mode for a predetermined time immediately after power is applied to the active filter, the image sensor, the image analyzer, and the filter controller.

4. The image sensor system of claim 3, wherein
the active filter operates in the blocking mode after the lapse of the predetermined time.

5. The image sensor system of claim 4, wherein
the filter controller switches the active filter to the pass mode or the blocking mode on the basis of the result of analyzing the image signal obtained from the image sensor after the lapse of the predetermined time.

6. The image sensor system of claim 5, wherein
the image analyzer generates a histogram for each wavelength of the image signal obtained from the image sensor, and
the filter controller varies the mode of the active filter in real time when a distribution of a cumulative number of pixels for each wavelength of the histogram for each wavelength of the image signal obtained from the image sensor is changed after the lapse of the predetermined time.

7. The image sensor system of claim 1, wherein
the image analyzer generates a histogram for each wavelength of the image signal obtained from the image sensor, and
the filter controller controls the active filter in the pass mode if the number of pixels receiving light having the infrared wavelength band, among pixels of the image sensor, is equal to or greater than a predetermined proportion to the entire pixels based on the histogram for each wavelength, and
the filter controller controls the active filter in the blocking mode if the number of pixels receiving light having the visible light wavelength band, among the pixels of the image sensor, is equal to or greater than the predetermined proportion to the entire pixels based on the histogram for each wavelength.

8. The image sensor system of claim 7, wherein
the filter controller maintains an operation mode of the active filter in a current mode for a predetermined holding time if cumulative pixel number shifting occurs between the infrared wavelength band and the visible light wavelength band in the histogram for each wavelength within a predetermined time.

9. The image sensor system of claim 7, wherein
the filter controller switches the operation mode of the active filter in response to an active filter setting change message received from an external server through V2X communication.

10. The image sensor system of claim 7, wherein
the image analyzer generates a histogram for each wavelength of an image signal output from another image sensor received through V2X communication, and
the filter controller controls the operation mode of the active filter on the basis of the histogram for each wavelength of the image signal output from the other image sensor.

11. A method of controlling an image sensor system, the method comprising:
analyzing an image signal output from an image sensor;
selecting a wavelength of light traveling to the image sensor by electrically controlling an active filter disposed in front of the image sensor on the basis of a result of analyzing the image signal;
allowing light having a specific wavelength to pass through the image sensor by controlling the active filter in a pass mode; and
blocking the light having the specific wavelength traveling to the image sensor by controlling the active filter in a blocking mode.

12. An autonomous driving system comprising:
a camera outputting an image signal and detecting an object from the image signal; and
an autonomous driving device reflecting the object information detected by the camera in driving of a vehicle,
wherein the camera comprises:
an active filter electrically controlled to allow light having an infrared wavelength to pass therethrough and block the light having the infrared wavelength;
an image sensor converting light passing through the active filter into an electrical signal and outputting an image signal;
an image analyzer analyzing the image signal obtained from the image sensor; and
a filter controller selecting a wavelength of light passing through the active filter by electrically controlling an operation mode of the active filter on the basis of a result of analyzing the image signal,
wherein the active filter allows light having a specific wavelength band to pass through the image sensor when operating in a pass mode and blocks the light having the specific wavelength band when operating in a blocking mode.

13. The autonomous driving system of claim 12, wherein
the active filter, which allows the light having the infrared wavelength band to pass through the image sensor and blocks light having a visible light wavelength band in the pass mode, blocks the light having the visible light wavelength band in the pass mode under the control of the filter controller.

14. The autonomous driving system of claim 12, wherein
the active filter operates in the pass mode for a predetermined time immediately after power is applied to the active filter, the image sensor, the image analyzer, and the filter controller.

15. The autonomous driving system of claim 14, wherein
the active filter operates in the blocking mode after the lapse of the predetermined time.

16. The autonomous driving system of claim 15, wherein
the filter controller switches the active filter to the pass mode or the blocking mode on the basis of the result of analyzing the image signal obtained from the image sensor after the lapse of the predetermined time.

17. The autonomous driving system of claim 16, wherein
the image analyzer generates a histogram for each wavelength of the image signal obtained from the image sensor, and
the filter controller varies the mode of the active filter in real time when a distribution of a cumulative number of pixels for each wavelength of the histogram for each wavelength of the image signal obtained from the image sensor is changed after the lapse of the predetermined time.

18. The autonomous driving system of claim 12, wherein
the image analyzer generates a histogram for each wavelength of the image signal obtained from the image sensor, and
the filter controller controls the active filter in the pass mode if the number of pixels receiving light having the infrared wavelength band, among pixels of the image sensor, is equal to or greater than a predetermined proportion to the entire pixels based on the histogram for each wavelength, and
the filter controller controls the active filter in the blocking mode if the number of pixels receiving light having the visible light wavelength band, among the pixels of the image sensor, is equal to or greater than the predetermined proportion to the entire pixels based on the histogram for each wavelength.

19. The autonomous driving system of claim 18, wherein
the filter controller maintains an operation mode of the active filter in a current mode for a predetermined holding time if cumulative pixel number shifting occurs between the infrared wavelength band and the visible light wavelength band in the histogram for each wavelength within a predetermined time.

20. The autonomous driving system of claim 18, wherein
the filter controller switches the operation mode of the active filter in response to an active filter setting change message received from an external server through V2X communication.
